(19) United States
(12) Patent Application Publication
(10) Pub. No.: US 2017/0279987 A1
(43) Pub. Date: Sep. 28, 2017

(54) Screen Display System, Screen Display Method, Image Processing Apparatus, and Recording Medium

(71) Applicant: Konica Minolta, Inc., Tokyo (JP)

(72) Inventors: Yoichi Kurumasa, Tokyokawa-shi (JP); Ryosuke Nishimura, Tokyokawa-shi (JP); Masayuki Ito, Nagoya-shi (JP); Hiroshi Sugiura, Tokyokawa-shi (JP)

(73) Assignee: Konica Minolta, Inc., Tokyo (JP)

(21) Appl. No.: 15/467,139

(22) Filed: Mar. 23, 2017

(30) Foreign Application Priority Data
Mar. 23, 2016 (JP) 2016-58079

(51) Int. Cl. H04N 1/00; G06T 3/40; G06T 3/60

(52) U.S. Cl. CPC H04N 1/00469; H04N 1/00129; H04N 1/00384; H04N 1/00474; H04N 1/00411; G06T 3/60; G06T 3/40; H04N 2201/0094

(57) ABSTRACT

A screen display system includes a portable terminal apparatus and an image processing apparatus connectable with each other. The portable terminal apparatus includes a transmitter that transmits a screen image and application information to the image processing apparatus. The image processing apparatus includes: a receiver that receives the screen image and the application information; a first judgment portion that judges whether or not the application supports both portrait and landscape orientations with reference to the application information; a display having a portrait or landscape display screen; and a display control processor that makes the display to display the screen image such that at least one part of the screen image is enlarged in a direction of the length of the screen image, if the application supports either portrait or landscape orientation and the orientation supported by the application does not match the orientation of the display screen of the display.

This application claims priority under 35 U.S.C. §119 to Japanese Patent Application No. 2016-058079 filed on Mar. 23, 2016, the entire disclosure of which is incorporated herein by reference.

### BACKGROUND OF THE INVENTION

Field of the Invention

The present invention relates to: a screen display system provided with a portable terminal apparatus and an image processing apparatus both being capable of connecting with each other; a screen display method; an image processing apparatus; and a recording medium, all of which allow the image processing apparatus to reproduce on its landscape display screen a screen image displayed on a display of the portable terminal apparatus.

Description of the Related Art

The following description sets forth the inventor's knowledge of related art and problems therein and should not be construed as an admission of knowledge in the prior art.

In a commonly known system, an image processing apparatus such as a multifunctional digital image forming apparatus (i.e. a multi-function peripheral abbreviated as MFP) having multiple functions e.g. copier function, printer function, facsimile function, and scanner function and a portable terminal apparatus such as a smartphone or a tablet computer are connected to each other. The system allows the image processing apparatus to receive a job and other data from the portable terminal apparatus and run the job.

With such a system, the user would be bothered by operating screens both on his/her own portable terminal apparatus and the image processing apparatus, which is a usability inconvenience.

As a solution to the usability inconvenience, a system that allows the image processing apparatus to reproduce on its display screen a screen image of the portable terminal apparatus has been conceived so that the user can give only one-step instructions to start running a job received from the portable terminal apparatus by operating the screen image of the portable terminal apparatus which is reproduced on the display of the image processing apparatus.

In this system, the portable terminal apparatus and the image processing apparatus are configured to communicate each other using a communication method such as WI-FI CERTIFIED MIRACAST or X WINDOW SYSTEM, which allows an apparatus to reproduce on its display a screen image displayed on a display of another apparatus:

Japanese Unexamined Patent Application Publication No. 2012-141570 discloses an image generating apparatus including: an image generator that generates image data; and a communication portion that transmits the image data to an image display apparatus and receives information related to the orientation of the image data displayed on the image display apparatus. The image generator generates image data with reference to the information related to the orientation, which is received by the communication portion.

This image processing apparatus can display on its display a screen image displayed on the portable terminal apparatus and received from the portable terminal apparatus using a technique that allows an apparatus to reproduce on its display a screen image displayed on a display of another apparatus by communicating therewith. The portable terminal apparatus, however, has a display screen smaller than that of the image processing apparatus, leaving a problem unsolved.

WI-FI CERTIFIED MIRACAST is aimed at only landscape screens such as wide screens with a 4:3 aspect ratio and a 16:9 aspect ratio. When the portable terminal apparatus transmits a portrait screen image to the image processing apparatus, the image processing apparatus displays the screen image in a so-called pillar-box screen format, i.e., in the middle area of the landscape display screen on the display. Masking areas are thus placed in both left and right periphery of the landscape display screen of the image processing apparatus and these look conspicuously large. This makes the screen image, which is received from the portable terminal 2 and displayed in the middle area of the landscape display screen, look inconspicuously small. The user would be bothered by multiple and tiny operation keys that are horizontally aligned in this small screen image.

The technique described in Japanese Unexamined Patent Application Publication No. 2012-141570 allows an apparatus to inquire whether the orientation of the display screen of a destination apparatus is portrait or landscape, to generate image data with reference to the answer, and to transmit the image data to the destination apparatus. Applying this technique to the known system, the portable terminal apparatus would need to have an additional function such that it can further generate image data depending on the orientation of the display screen of the image processing apparatus, which is a troublesome alternative.

### SUMMARY OF THE INVENTION

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

A first aspect of the present invention relates to a screen display system including:

a portable terminal apparatus; and

an image processing apparatus being capable of connecting with the portable terminal apparatus,

the portable terminal apparatus including:
a display; and
a transmitter that transmits a screen image and application information to the image processing apparatus, the screen image being displayed on the display of the portable terminal apparatus, the application information representing whether an application related to reproduction of the screen image supports both portrait and landscape orientations,

the image processing apparatus including:
a receiver that receives the screen image and the application information from the portable terminal apparatus;
a first judgment portion that judges whether or not the application supports both portrait and landscape orientations with reference to the application information received by the receiver;
a display having a portrait or landscape display screen; and
a display control processor that makes the display of the image processing apparatus to display the screen image received by the receiver such that at least one part of the screen image is enlarged in a direction of the length of the screen image, if the first judgment portion judges that the application supports either portrait or landscape orientation and the orientation supported by the application does not match the orientation of the display screen of the display of the image processing apparatus.

A second aspect of the present invention relates to a screen display method to be implemented by a screen display system, the screen display system including:

a portable terminal apparatus; and

an image processing apparatus including a display having a portrait or landscape display screen, the image processing apparatus being capable of connecting with the portable terminal apparatus,

the screen display method including the following step of the portable terminal apparatus:
transmitting a screen image and application information to the image processing apparatus, the screen image being displayed on the display of the portable terminal apparatus, the application information representing whether or not an application related to reproduction of the screen image supports both portrait and landscape orientations; and

the screen display method including the following steps of the image processing apparatus:
receiving the screen image and the application information from the portable terminal apparatus;
judging whether or not the application supports both portrait and landscape orientations with reference to the application information received therefrom; and
making the display of the image processing apparatus to display the screen image received from the portable terminal apparatus such that at least one part of the screen image is enlarged in a direction of the length of the screen image, if it is judged that the application supports either portrait or landscape orientation and the orientation supported by the application does not match the orientation of the display screen of the display of the image processing apparatus.

A third aspect of the present invention relates to an image processing apparatus being capable of connecting with an portable terminal apparatus, the image processing apparatus including:

a receiver that receives a screen image and application information from the portable terminal apparatus, the screen image being displayed on the portable terminal apparatus, the application information representing whether an application related to reproduction of the screen image supports both portrait and landscape orientations,

a first judgment portion that judges whether or not the application supports both portrait and landscape orientations with reference to the application information received by the receiver;

a display having a portrait or landscape display screen; and

a display control processor that makes the display to display the screen image received by the receiver such that at least one part of the screen image is enlarged in a direction of the length of the screen image, if the first judgment portion judges that the application supports either portrait or landscape orientation and the orientation supported by the application does not match the orientation of the display screen of the display.

A fourth aspect of the present invention relates to a non-transitory computer-readable recording medium for an image processing apparatus including a display having a portrait or landscape display screen, the image processing apparatus being capable of connecting with a portable terminal apparatus, the non-transitory computer-readable recording medium storing a screen display program with instructions to make a computer of the image processing apparatus execute the following steps:

receiving a screen image and application information from the portable terminal apparatus, the screen image being displayed on the portable terminal apparatus, the application information representing whether an application related to reproduction of the screen image supports both portrait and landscape orientations,

judging whether or not the application supports both portrait and landscape orientations with reference to the application information received therefrom; and

making the display to display the screen image received therefrom such that at least one part of the screen image is enlarged in a direction of the length of the screen image, if it is judged that the application supports either portrait or landscape orientation and the orientation supported by the application does not match the orientation of the display screen of the display.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying drawings, in which:

FIG. 1 illustrates the configuration of an image display system according to one embodiment of the present invention;

FIG. 2 is a block diagram illustrating the configuration of an image processing apparatus;

FIG. 3 is a block diagram illustrating the configuration of a portable terminal apparatus;

FIG. 4 is an explanatory view on the heretofore known embodiment in which the image processing apparatus displays on its display a portrait screen image received from the portable terminal apparatus;

FIG. 5 is an explanatory view on the present embodiment in which the image processing apparatus displays on its display a portrait screen image received from the portable terminal apparatus;

FIGS. 6A, 6B, 6C, and 6D are explanatory views on the operations how the image processing apparatus requests for a landscape screen image in response to a portrait screen image received from the portable terminal apparatus and how the image processing apparatus displays the landscape screen image on its display;

FIG. 7 is an explanatory flowchart on the operation of the image processing apparatus;

FIG. 8 is an explanatory flowchart on the operation of the portable terminal apparatus;

FIG. 9 is an explanatory flowchart on the operation of the image processing apparatus according to another embodiment; and

FIG. 10 is a subsequent flowchart following the FIG. 9 flowchart.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one embodiment of the present invention will be described with reference to the accompanying drawings.

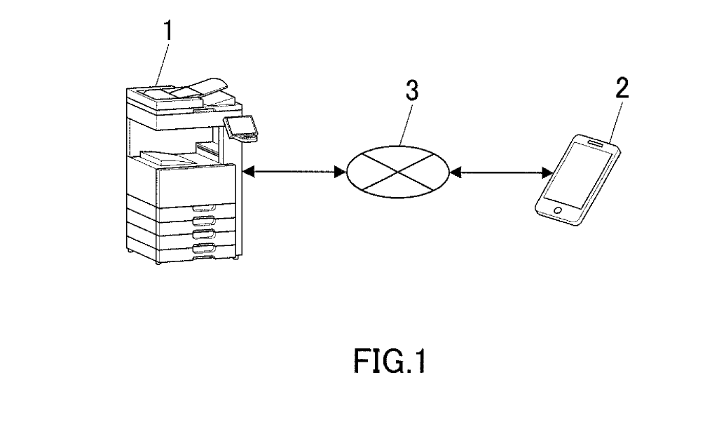

FIG. 1 illustrates the configuration of an image display system according to one embodiment of the present invention.

The image display system is provided with an image processing apparatus 1 and a portable terminal apparatus 2; the image processing apparatus 1 and the portable terminal apparatus 2 are capable of being connected to each other through a network 3.

The network 3 may be any of the following: a private line such as a network local area network (LAN), a public network, and a wireless network. The network 3 is indirectly connected with other networks through external networks.

The image processing apparatus 1 generates a copy image from print data obtained by document scanning or print data received from the portable terminal apparatus 2 and forms the copy image on paper. In this embodiment, an MFP i.e. a multifunctional digital image processing apparatus having printer function, facsimile function, scanner function, and other functions as described above is employed as the image processing apparatus 1. Hereinafter, an image processing apparatus will also be referred to as “MFP”.

The portable terminal apparatus 2 is a portable computer terminal such as a smartphone or a tablet computer, essentially provided with a CPU, a RAM, a fixed storage device (a hard disk drive, for example), a monitor, and a touch-enabled liquid-crystal display panel. Users can carry their own portable terminal apparatuses 2 with them and can view and edit anywhere electronic documents stored thereon. The portable terminal apparatus 2 is further provided with a wireless communication means that allows the portable terminal apparatus 2 to exchange documents with the MFP 1 wirelessly and a remote control means that allows the portable terminal apparatus 2 to operate the MFP 1 remotely. Hereinafter, a portable terminal apparatus will also be referred to as “portable terminal” for the sake of simplicity.

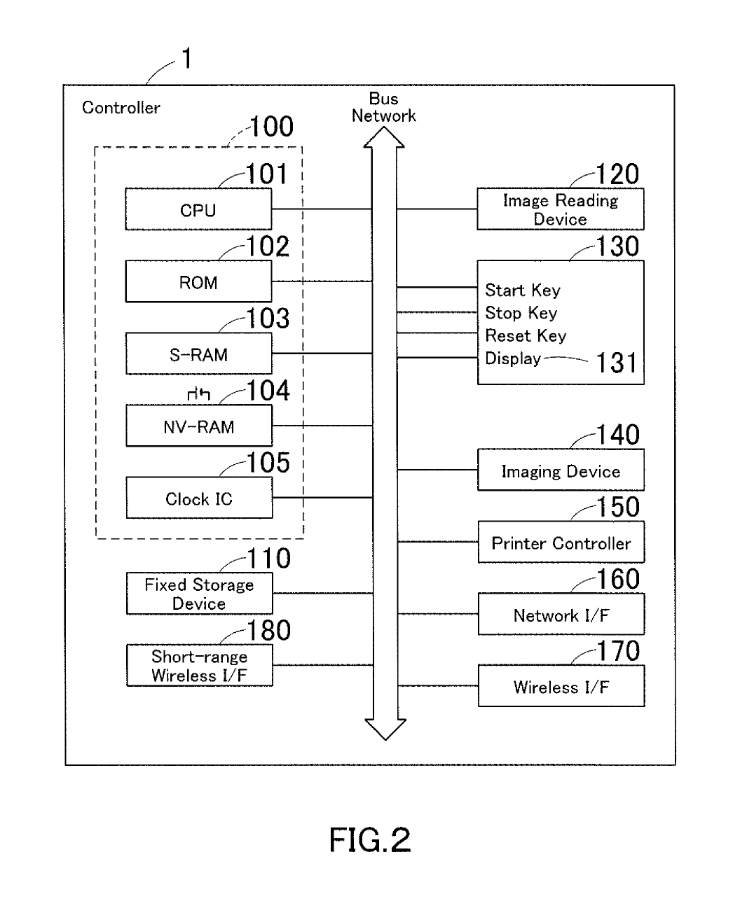

FIG. 2 is a block diagram illustrating the configuration of the MFP 1. The CPU 101 of the MFP 1 is connected with a ROM 102 that stores operation programs, a static random access memory (S-RAM) 103 for fast processing, a battery-backed non-volatile memory (NV-RAM) 104 that stores various settings for image forming, and a block IC 105, through a bus network. The CPU 101 constitutes a controller 100 that controls the MFP 1 in a unified and systematic manner.

The controller 100 is connected with the following portions through a bus network: an image reading device 120 for document scanning; an operation panel 130 having a display 131 and various operation keys such as a start key for starting running a job, a stop key for stopping a running job, and a reset key for resetting settings; a network interface (network I/F) 160 that exchanges information of various types with an external apparatus connected to the image processing apparatus 1 through the network 3, such as the portable terminal 2; a printer controller 150 that generates a copy image from print data received by the network interface 160; and an imaging device 140 that forms the copy image on paper.

The display 131 constitutes a liquid-crystal display device with a touch panel, for example. In this embodiment, the display 131 has a landscape display screen i.e. a display screen with its horizontal dimension greater than its vertical dimension.

The controller 100 is further connected with a fixed storage device 110 through the bus network. The fixed storage device 110 is a hard disk drive, for example. The fixed storage 110 stores data of various types.

The controller 100 is further connected with a wireless interface (wireless I/F) 170 and a short-range wireless interface (short-range wireless I/F) 180 through the bus network. The wireless interface 170 serves for communications with the network and the portable terminal 2. The short-range wireless interface 180 is an interface that serves for short-range wireless communications such as BLUETOOTH wireless communication and infrared wireless communication using the infrared data association (IRDA) standard protocol.

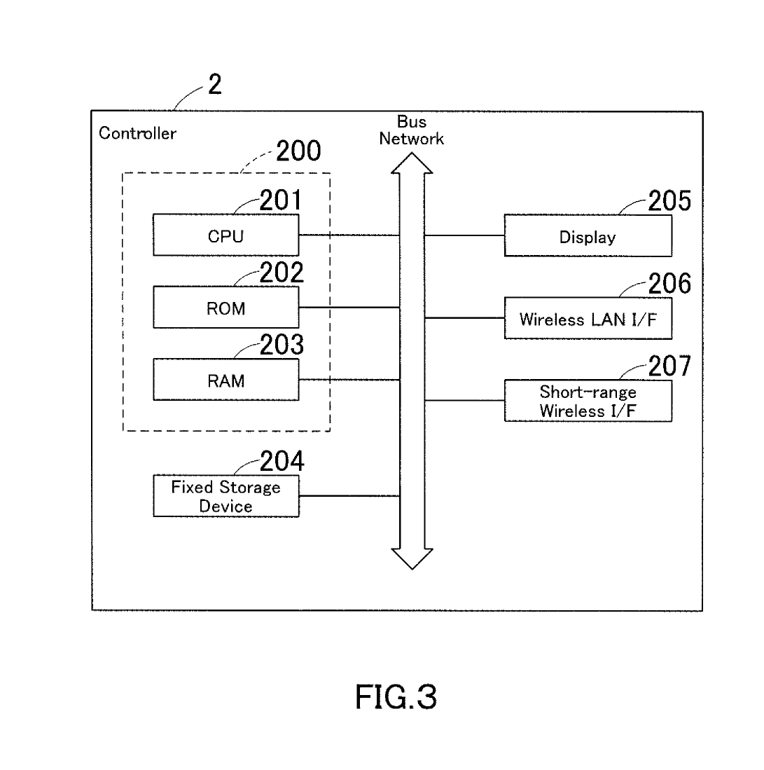

FIG. 3 is a block diagram illustrating the configuration of the portable terminal 2. The portable terminal 2 is provided with a CPU 201, a ROM 202 that stores operation programs, and a RAM 203 for fast processing. The ROM 202 and the RAM 203 are connected with the CPU 201 through a bus network. The CPU 201, the ROM 202, and the RAM 203 constitute a controller 200 that controls the portable terminal 2 in a unified and systematic manner.

The controller 200 is connected with: a display 205 that constitutes a liquid-crystal display device with a touch panel, displays information of various types, and allows users to give instructions by physically touching the screen; a wireless LAN interface 206; and a short-range wireless interface 207. The wireless LAN interface 206 serves for communications with the network and the MFP 1. The short-range wireless interface 207 is an interface that serves for short-range wireless communication such as BLUETOOTH wireless communication and infrared wireless communication.

The display 205 displays a display screen in portrait orientation when the portable terminal 2 is used in portrait orientation; the display 205 displays a display screen in landscape orientation when the portable terminal 2 is used in landscape orientation. Although it is not shown in this figure, the portable terminal 2 is further provided with an accelerometer that judges the orientation of the portable terminal 2.

The portable terminal 2 has an application installed thereon to operate in cooperation with the MFP 1. This application includes contents to reproduce screen images on the display 205. The application may support both portrait and landscape orientations. In this case, the portable terminal 2 displays a portrait screen image on the display 205 upon the accelerometer judging that the portable terminal 2 is used in portrait orientation; the portable terminal 2 displays a landscape screen image on the display 205 upon the accelerometer judging that the portable terminal 2 is used in landscape orientation. The application may support only portrait orientation; in this case, the portable terminal 2 displays a portrait screen image on the display 205 regardless of whether the portable terminal 2 is used in portrait or landscape orientation.

The controller 200 is further connected with a fixed storage device 204 through the bus network. The fixed storage device 204 is a hard disk drive, for example. The fixed storage device 204 stores data of various types, including the above-described application.

Hereinafter, the operations of the screen display system illustrated in FIG. 1 will be described.

The user activates the application for operating in cooperation with the MFP 1, which is installed on the portable terminal 2. Being activated, the application reproduces an operation screen image on the touch panel 205 of the portable terminal 2 using the contents included in the application itself

The user presses a button for operating in cooperation with the portable terminal 2 (not shown in this figure), which is displayed on the display 131 of the MFP 1. Upon the button being pressed, the portable terminal 2 transmits a screen image displayed on the operation panel 205 to the MFP 1. The MFP 1 then displays the screen image on the display 131. The portable terminal 2 transmits the screen image using WI-FI CERTIFIED MIRACAST, for example, which does not mean that the communication method is limited to WI-FI CERTIFIED MIRACAST as a matter of course.

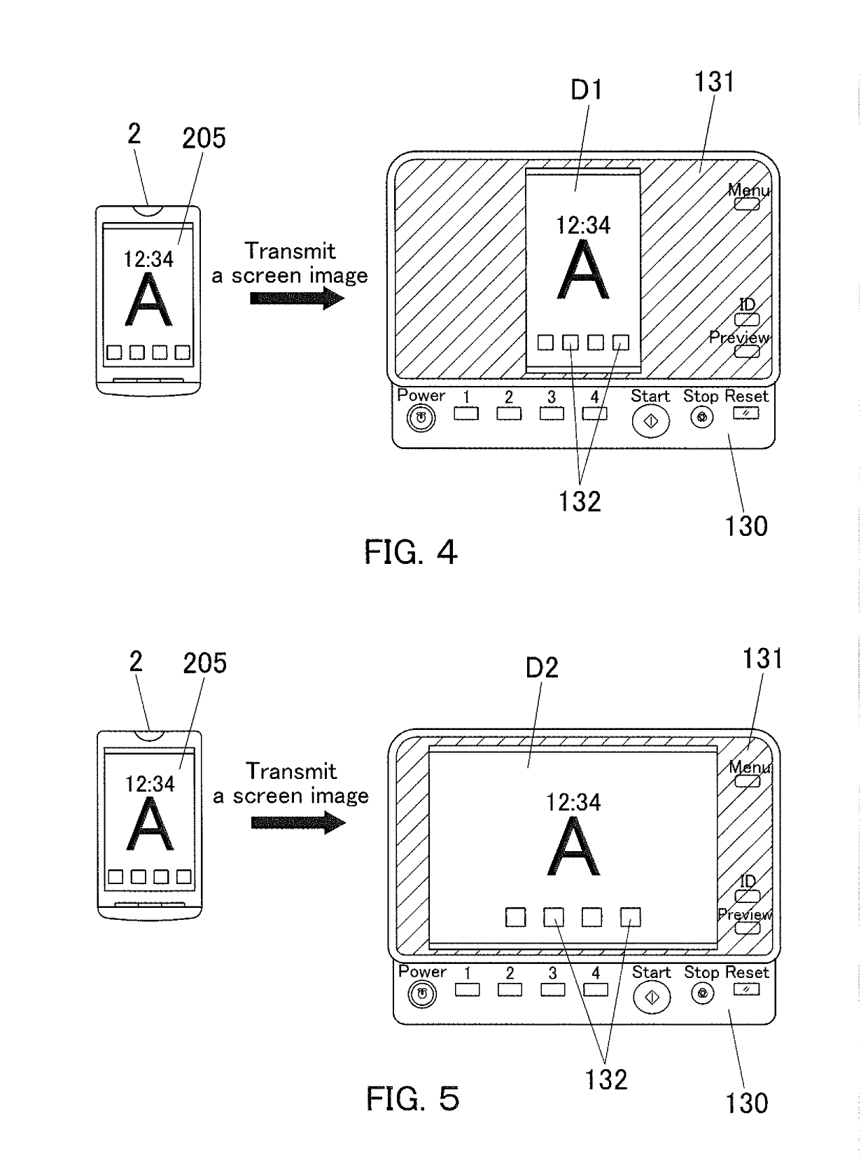

In this embodiment, it is assumed that the portable terminal 1 is normally used in portrait orientation and the application for reproducing the screen image displayed on the portable terminal 2 supports only portrait orientation. When the portable terminal 2 transmits a portrait screen image to the MFP 1, the MFP 1 displays the screen image, which is displayed on the display 205 of the portable terminal 2, in an adjacent area of the middle of the landscape (wide) display screen of the display 131 with masking areas placed on both sides of the screen image, as referred to a screen D1 illustrated in FIG. 4. As indicated by hatching in this figure, these masking areas are conspicuously large and placed in both right and left periphery of the display screen of the MFP 1. This makes the screen image, which is received from the portable terminal 2, look inconspicuously small. Referring to FIG. 4, each operation key is provided with a code 132, and there are multiple operation keys that are horizontally aligned at intervals.

In this embodiment, the portable terminal 2 transmits the following pieces of information to the MFP 1 along with a screen image for reproducing a screen: application information whether or not the application supports both portrait and landscape orientations; the display resolution of the display 205 of the portable terminal 2; the positions of the operation keys 132 on the screen image; and other information.

The MFP 1 thus receives the screen image, the application information, the display resolution, the positions of the operation keys, and other information from the portable terminal 2. Subsequently, the MFP 1 judges whether or not the application supports both portrait and landscape orientations, with reference to the application information received therefrom.

If the application supports only portrait orientation, the MFP 1 displays the portrait screen image such that the multiple operation keys 132 are horizontally aligned at longer intervals, as referred to a screen D2 illustrated in FIG. 5. The MFP 1 may display the portrait screen image such that the operation keys 132 are horizontally aligned at longer intervals as described above and, if needed, the operation keys 132 are further enlarged either or both of vertically and horizontally. As illustrated in FIG. 5, the MFP 1 may enlarge the background of the screen image horizontally on the display 131.

As described above, in a case in which the display 131 of the MFP 1 has a landscape display screen and the portable terminal 2 has an application that supports only portrait orientation, the MFP 1 displays a portrait screen image received from the portable terminal 2 such that the multiple operation keys 132 are horizontally aligned at longer intervals, as referred to a screen D2 illustrated in FIG. 5. This will allow an effective use of the landscape display screen of the display 131 of the MFP 1 and will also improve the usability of the screen image received from the portable terminal 2, specifically, the usability of tiny operation keys on the screen image. In this embodiment, there is no need anymore for the portable terminal 2 to generate a screen image that will fit in the display screen of the MFP 1; the portable terminal 2 therefore does not need to have an additional function such that it can further generate a screen image.

Similarly, in a case in which the display 131 of the MFP 1 has a portrait display screen and the portable terminal 2 has an application that supports only landscape orientation, the MFP 1 displays a landscape screen image received from the portable terminal 2 such that the operation keys, if there exist, are vertically aligned at longer intervals.

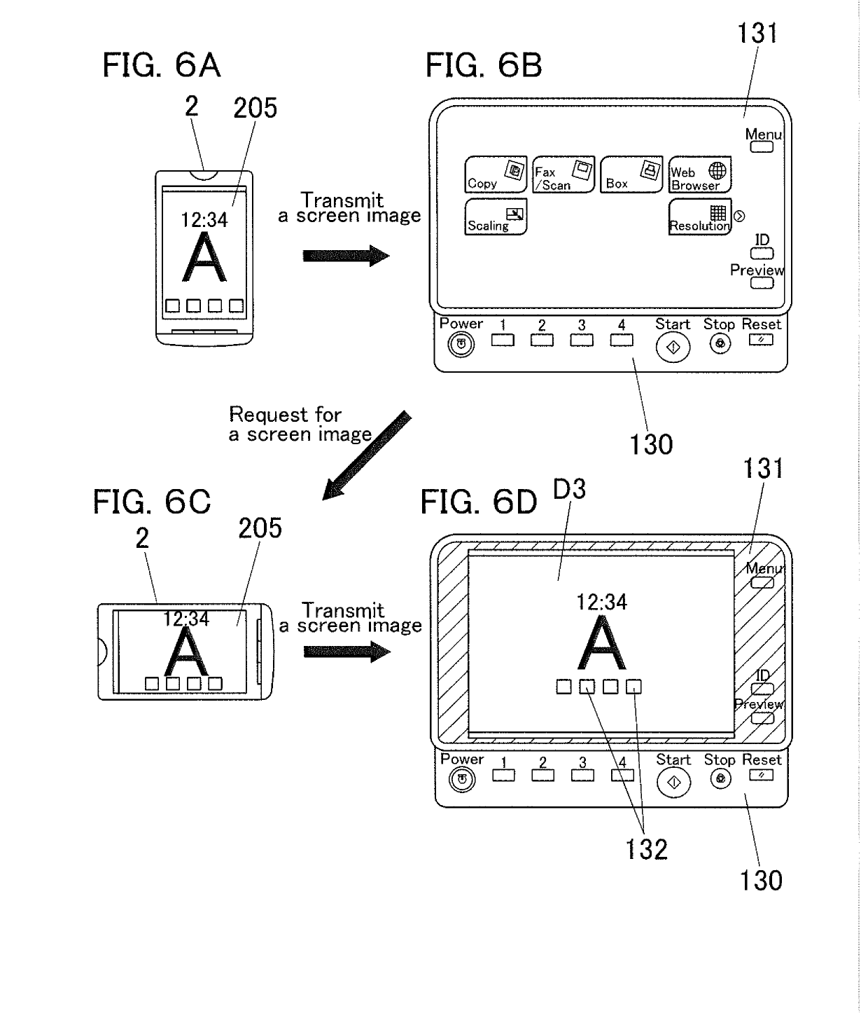

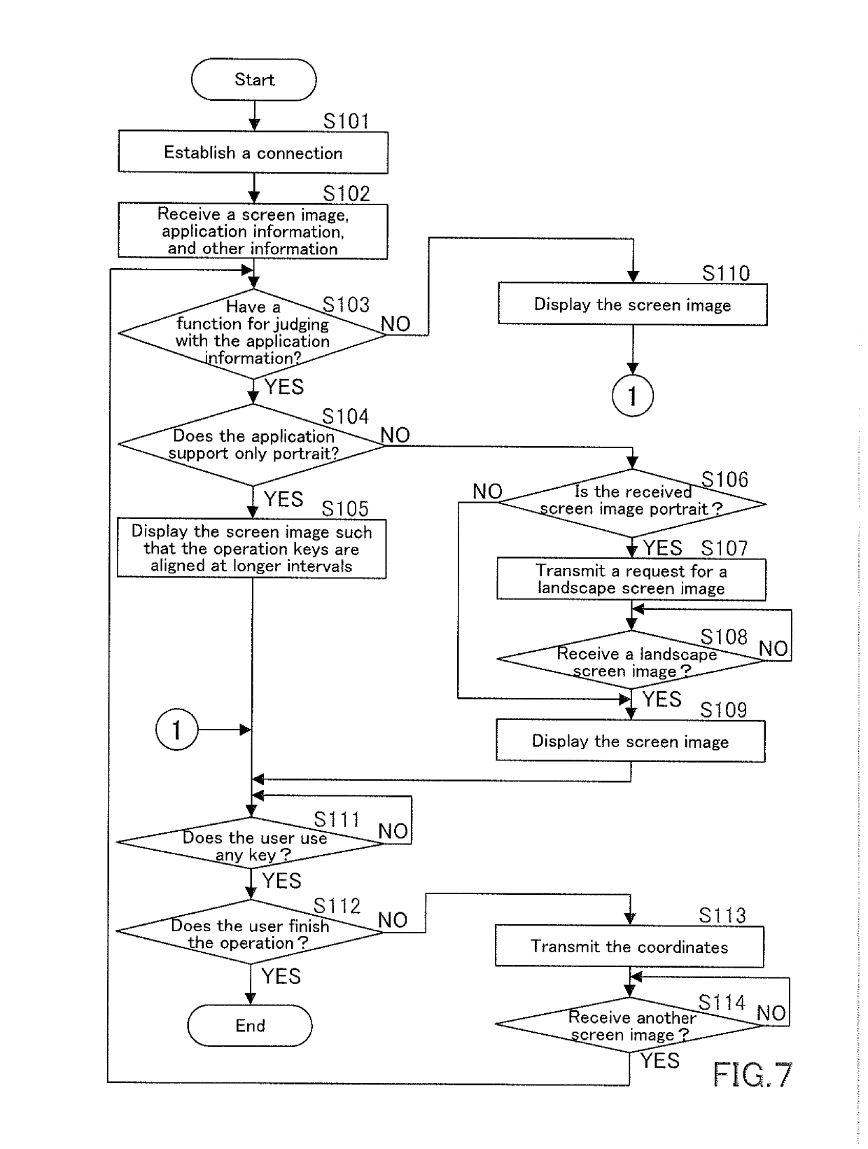

To describe the same with reference to FIGS. 6A, 6B, 6C, and 6D, the portable terminal 2 illustrated in FIG. 6A transmits a portrait screen image and the application information to the MFP 1 illustrated in FIG. 6B. If the MFP 1 judges that the application installed on the portable terminal 2 supports both portrait and landscape orientations, with reference to the application information received therefrom, the MFP 1 transmits to the portable terminal 2 a request for a landscape screen image that will match the orientation of the display screen of the display 131, as illustrated in FIG. 6C. In response to the request received from the MFP 1, the portable terminal 2 returns a landscape screen image to the MFP 1. Receiving the screen image, the MFP 1 displays it on the display 131, as illustrated in FIG. 6D. On the landscape screen image, the operation keys 132 are normally aligned at intervals long enough and sized large enough already. The MFP 1 may thus display the landscape screen image without adjusting the intervals or the sizes of the operation keys 132, or the MFP 1 may alternatively display it such that the operation keys 132 are aligned at even longer intervals and the operation keys 132 are further enlarged. The MFP 1 may display the screen image on the display 131 such that the background of the screen image is enlarged vertically and horizontally.

FIG. 7 is an explanatory flowchart on the operation of the MFP 1. This operation is executed by the CPU 101 of the MFP 1 in accordance with an operation program stored on a memory such as the ROM 102.

In the example of FIG. 7, it is assumed that the display 131 of the MFP 1 has a landscape (wide) display screen and the application supports only portrait orientation or both portrait and landscape orientations.

In Step S101, the MFP 1 establishes a connection with the portable terminal 2. The routine then proceeds to Step S102, in which the MFP 1 receives, from the portable terminal 2, a screen image displayed on the display 205 of the portable terminal 2, application information on an application for reproducing screen images, the display resolution of the display 205, the positions of the operation keys and other objects, and other information.

In Step S103, the MFP 1 judges whether it has a function for judging whether or not the application that reproduces screen images displayed on the portable terminal 2 supports both portrait and landscape orientations, with reference to the application information. If the MFP 1 does not have it (NO in Step S103), the MFP 1 displays the received screen image on the display 131 in Step S110. The flowchart then proceeds to Step S111.

If the MFP 1 has such a function as described above (YES in Step S103), the MFP 1 then judges in Step 5104 whether or not the application supports only portrait orientation.

If the application supports only portrait orientation (YES in Step S104), the received screen image must be a portrait screen image. In Step S105, the MFP 1 thus displays the portrait screen image on the display 131 such that the operation keys are aligned at longer intervals and, if needed, the operation keys are further enlarged vertically and horizontally. The routine then proceeds to Step S111.

Back to Step S104, if the application does not support only portrait orientation, i.e., if the application supports both portrait and landscape orientations (NO in Step S104), the MFP 1 then judges in Step S106 whether or not the received screen image is a portrait screen image. The MFP 1 may judge whether or not it is a portrait screen image with reference to information such as the vertical and horizontal size of the received screen image. Such information may be received from the portable terminal 2.

If it is a portrait screen image (YES in Step S106), the MFP 1 transmits a request for a landscape screen image to the portable terminal 2 in Step S107, and waits to receive a landscape screen image from the portable terminal 2 in Step S108 (NO in Step S108). If the MFP 1 receives it (YES in Step S108), the routine proceeds to Step S109. Back to Step S106, if the received screen image is not a portrait screen image (NO in Step S106), it must be a landscape screen image. The routine then proceeds directly to Step S109.

In Step S109, the MFP 1 displays the landscape screen image on the display 131 without adjusting the intervals or the sizes of the operation keys, or the MFP 1 alternatively displays it such that the operation keys are aligned at intervals even longer than normal intervals and the operation keys are further enlarged vertically and horizontally. The routine then proceeds to Step S111.

In Step S111, the MFP 1 waits for the user to use any of the operation keys (NO in Step S111). If the user uses any of the operation keys (YES in Step S111), the MFP 1 then judges in Step S112 whether the user finishes the operation. If the user finishes the operation (YES in Step S121), the routine terminates. If the user does not finish the operation (NO in Step S112), the MFP 1 transmits the coordinates of a key touched by the user to the portable terminal 2 in Step S113, and waits to receive another screen image from the portable terminal 2 in Step S114 (NO in Step S114). If the MFP 1 receives it (YES in Step S114), the routine returns to Step S104. The coordinates of the touched key may relate to instructions to start running a job, for example; in this case, the MFP 1 receives instructions to start running a job and other data from the portable terminal 2 and starts running the job accordingly.

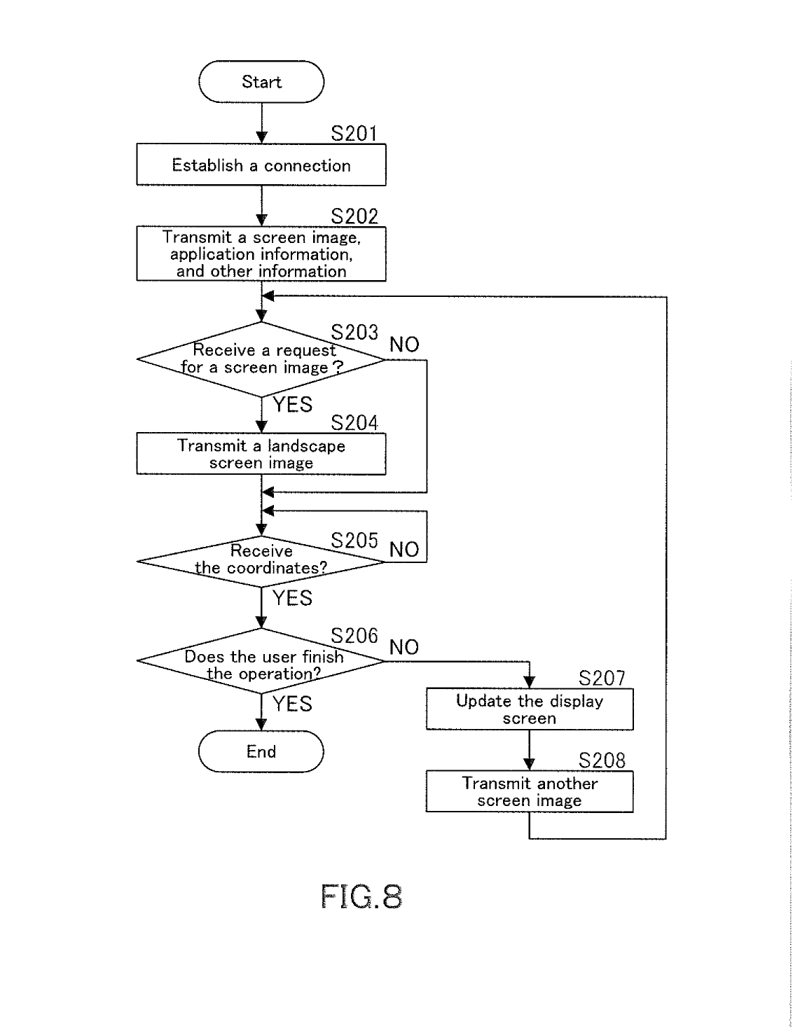

FIG. 8 is an explanatory flowchart on the operation of the portable terminal apparatus. This operation is executed by the CPU 201 of the portable terminal 2 in accordance with an operation program stored on a memory such as the ROM 202.

The user activates the application for operating in cooperation with the MFP 1. In Step S201, the portable terminal 2 establishes a connection with the MFP 1. The routine then proceeds to Step S202, in which the portable terminal 2 transmits, to the MFP 1, a screen image displayed on the display 205, application information on the application for reproducing screen images, the display resolution of the display 205, the positions of the operation keys and other objects, and other information.

In Step S203, the portable terminal 2 judges whether or not it receives a request for a screen image from the MFP 1. If the portable terminal 2 receives it (YES in Step S203), the portable terminal 2 transmits a request for a landscape screen image to the MFP 1 in Step S204. The routine then proceeds to Step S205. If the portable terminal 2 does not receive such a request (NO in Step S203), the routine proceeds directly to Step S205.

In Step S205, the portable terminal 2 waits to receive coordinates from the MFP 1 (NO in Step S205). If the portable terminal 2 receives them (YES in Step S205), the portable terminal 2 then judges in Step S206 whether or not the user finishes the operation. If the user finishes the operation (YES in Step S206), the routine terminates. If the user does not finish the operation (NO in Step S206), the routine proceeds to Step S207, in which the portable terminal 2 updates the display screen with a screen image suitable for the operation and transmits the screen image to the MFP 1. The routine then returns to Step S203.

The operation may be giving instructions to start running a job, for example; in this case, the portable terminal 2 transmits instructions to start running a job, not a screen image, to the MFP 1. Receiving the instructions, the MFP 1 starts running a job accordingly.

The portable terminal 2 may have an application that supports only landscape orientation. In this case, the MFP 1 judges whether the contents included in the application are aimed at only landscape screen images in Step S104. If they are aimed at only landscape screen images (YES in Step S104), the routine proceeds to Step S105, in which the MFP 1 displays a landscape screen image on the portrait display screen of the display 131 such that the operation keys are vertically aligned at longer intervals.

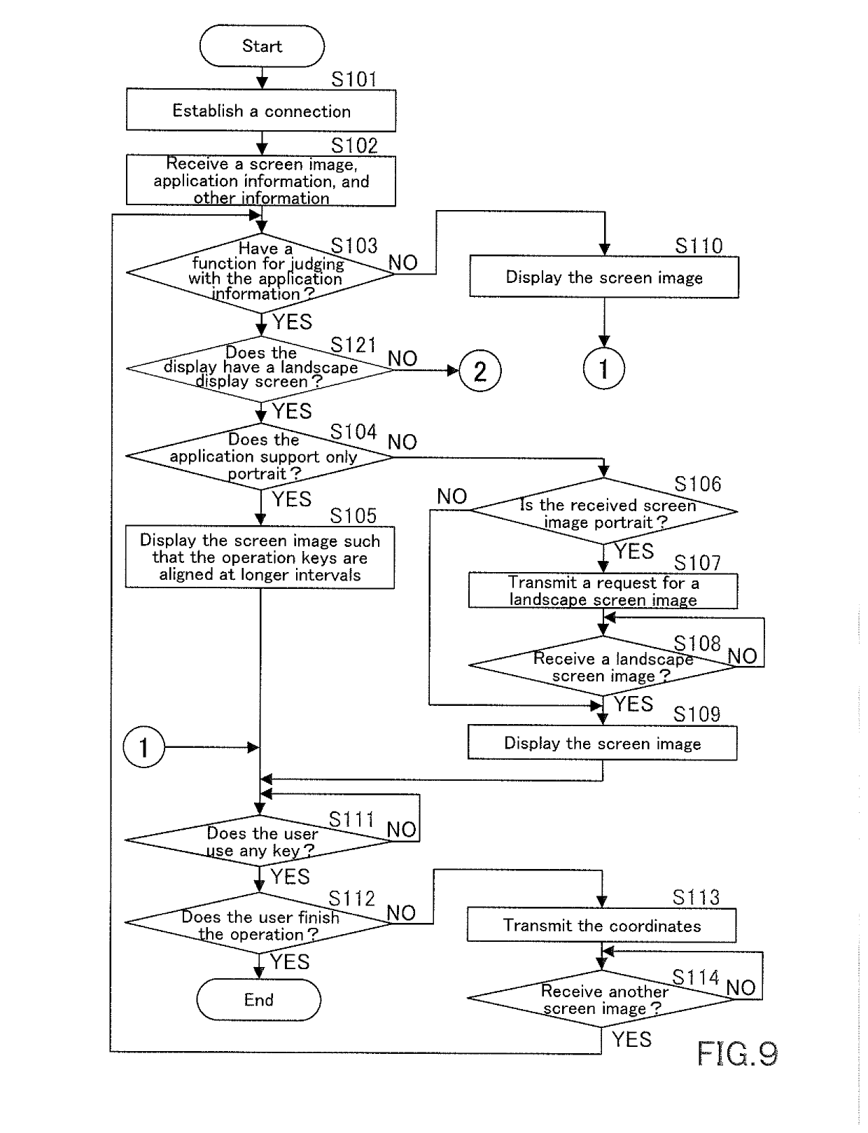

FIG. 9 is a flowchart representing the operation of the MFP 1 according to another embodiment of the present invention. In this embodiment, the MFP 1 is configured such that the operation panel 130 including the display 131 can be rotated in plane with the display screen. The user can change the orientation of the display screen by rotating the operation panel 130. The CPU 101 is capable of judging the present orientation of the operation panel 130 (the display 131) using a sensor not shown in this figure.

Furthermore, in this embodiment, it is assumed that the application supports only portrait orientation or both portrait and landscape orientations.

Hereinafter, Step S121 will be mainly described because the FIG. 9 flowchart is identical with the FIG. 7 flowchart except for only one step that is Step S121.

In Step S103, the MFP 1 judges whether or not it has a function for judging whether the application that reproduces screen images displayed on the portable terminal 2 supports both portrait and landscape orientations, with reference to the application information. If the MFP 1 has such a function, the MFP 1 then judges in Step S121 whether or not the display 131 has a landscape (wide) display screen. If it has a landscape display screen (YES in Step S121), the routine proceeds to Step S104 that is identical with that of the FIG. 7 flowchart.

If the MFP 1 does not have a landscape display screen, i.e., if the MFP 1 has a portrait display screen (NO in Step S121), the MFP 1 then judges in Step S131 whether the contents included in the application are aimed at only portrait screen images. If they are aimed at only portrait screen images (YES in Step S131), the routine proceeds to Step S132, in which the MFP 1 displays the portrait screen image on the portrait display screen of the display 131 without adjusting the intervals or the sizes of the operation keys, or the MFP 1 alternatively displays it on the portrait display screen of the display 131 such that the operation keys are aligned at longer intervals and the operation keys are further enlarged vertically and horizontally. The routine then proceeds to Step S111 of the FIG. 9 flowchart.

Back to Step S131, if the application supports not only portrait orientation, i.e., if the application supports both portrait and landscape orientations (NO in Step S131), the MFP 1 then judges in Step S133 whether or not the received screen image is a portrait screen image. If it is not a portrait screen image (NO in Step S133), the MFP 1 transmits a request for a portrait screen image to the portable terminal 2 in Step S134, and waits to receive a portrait screen image from the portable terminal 2 in Step S135 (NO in Step S135). If the MFP 1 receives it (YES in Step S135), the routine proceeds to Step S136. Back to Step S133, if the received screen image is a portrait screen image (YES in Step S133), the routine proceeds directly to Step S136.

In Step S136, the MFP 1 displays the portrait screen image on the display 131 without adjusting the intervals or the sizes of the operation keys, or the MFP 1 alternatively displays it such that the operation keys are aligned at intervals even longer than normal intervals and the operation keys are further enlarged vertically and horizontally. The routine then proceeds to Step S111 of the FIG. 9 flowchart.

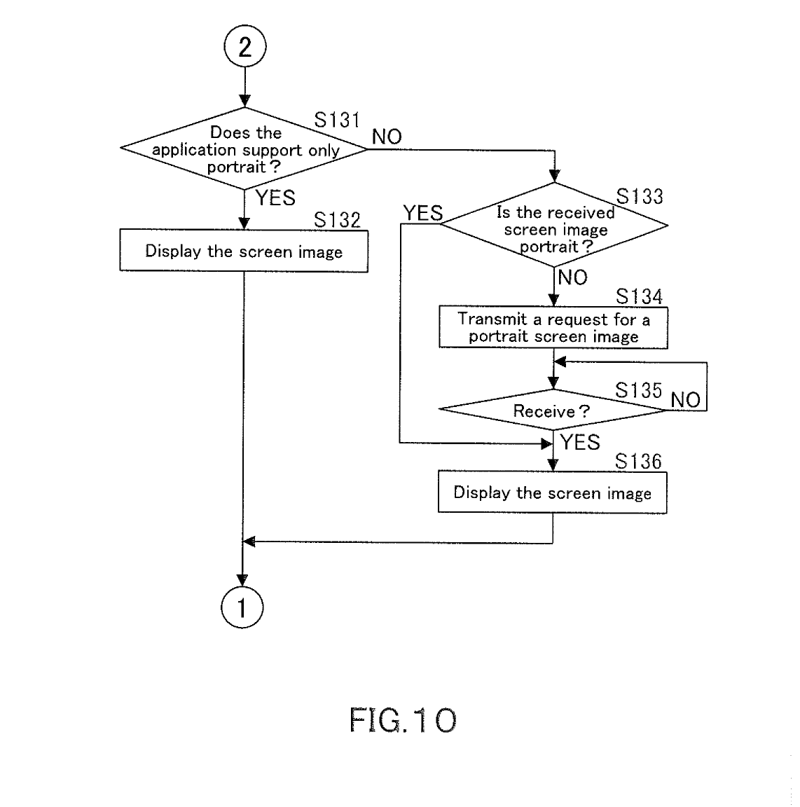

The portable terminal 2 may have an application that supports only landscape orientation. In this case, in the embodiment described with reference to FIGS. 9 and 10, the MFP 1 judges in Step S131 of the FIG. 10 flowchart whether or not the contents included in the application is aimed at only landscape screen images. If they are aimed at only landscape screen images, the routine proceeds to Step S132, in which the MFP 1 displays the screen image such that the operation keys, if there exist, are vertically aligned at longer intervals.

While some embodiments of the present invention have been described in details herein it should be understood that the present invention is not limited to the foregoing embodiments. For example, the MFP 1 judges whether the received screen image is a portrait screen image in Step S106 of the FIG. 6 flowchart and the FIG. 7 flowchart; instead of making such a judgment, the MFP 1 may transmit a request for a landscape screen image in this step. For another example, the portable terminal 2 may be configured to transmit only landscape screen images to the MFP 1 as long as the portable terminal 2 has an application that supports both portrait and landscape orientations. This configuration allows the MFP 1 to display a received landscape screen image in Step S109 immediately after the judgment in Step S104.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A screen display system comprising:
a portable terminal apparatus; and
an image processing apparatus being capable of connecting with the portable terminal apparatus,
the portable terminal apparatus comprising:
a display; and
a transmitter that transmits a screen image and application information to the image processing apparatus, the screen image being displayed on the display of the portable terminal apparatus, the application information representing whether an application related to reproduction of the screen image supports both portrait and landscape orientations,
the image processing apparatus comprising:
a receiver that receives the screen image and the application information from the portable terminal apparatus;
a first judgment portion that judges whether or not the application supports both portrait and landscape orientations with reference to the application information received by the receiver;
a display having a portrait or landscape display screen; and
a display control processor that makes the display of the image processing apparatus to display the screen image received by the receiver such that at least one part of the screen image is enlarged in a direction of the length of the screen image, if the first judgment portion judges that the application supports either portrait or landscape orientation and the orientation supported by the application does not match the orientation of the display screen of the display of the image processing apparatus.

2. The screen display system according to claim 1, wherein:
the display of the image processing apparatus has a landscape display screen and the application supports only portrait orientation;
multiple operation keys are horizontally aligned at intervals on the screen image; and
the display control processor makes the display of the image processing apparatus to display the screen image such that the multiple operation keys are horizontally aligned at longer intervals.

3. The screen display system according to claim 1, wherein:
the image processing apparatus transmits a request for a screen image to the portable terminal apparatus, the screen image being oriented with respect to the orientation of the display screen of the display of the image processing apparatus, if the first judgment portion judges that the application supports both portrait and landscape orientations; and
the transmitter transmits the screen image to the image processing apparatus in response to the request.

4. The screen display system according to claim 3, wherein:
the image processing apparatus further comprises a second judgment portion that judges whether or not the screen image received from the portable terminal apparatus is oriented with respect to the orientation of the display screen of the display of the image processing apparatus; and
the image processing apparatus transmits a request for a screen image to the portable terminal apparatus, the screen image being oriented with respect to the orientation of the display screen of the display of the image processing apparatus, if the second judgment portion judges that the screen image received from the portable terminal apparatus is not oriented with respect to the orientation of the display screen of the display of the image processing apparatus.

5. The screen display system according to claim 1, wherein:
the image processing apparatus further comprises:
an orientation changer that allows the display of the image processing apparatus to change the orientation of the display screen between portrait and landscape as the display of the image processing apparatus is rotated; and
a third judgment portion judges whether the display screen of the display of the image processing apparatus is oriented with respect to portrait or landscape by the orientation switch, wherein the display control processor makes the display of the image processing apparatus to display the screen image received by the receiver such that at least one part of the screen image is enlarged at least in a direction of the length of the screen image, if the first judgment portion judges that the application supports either portrait or landscape orientation and the orientation supported by the application does not match the orientation of the display screen of the display of the image processing apparatus, the orientation being judged by the third judgment portion.

6. The screen display system according to claim 1, further comprising a fourth judgment portion that judges whether or not the image processing apparatus has the first judgment portion, wherein the first judgment portion is enabled if the fourth judgment portion judges that the image processing apparatus has the first judgment portion.

7. A screen display method to be implemented by a screen display system, the screen display system comprising:
a portable terminal apparatus; and
an image processing apparatus comprising a display having a portrait or landscape display screen, the image processing apparatus being capable of connecting with the portable terminal apparatus,
the screen display method comprising the following step of the portable terminal apparatus:
transmitting a screen image and application information to the image processing apparatus, the screen image being displayed on a display of the portable terminal apparatus, the application information representing whether or not an application related to reproduction of the screen image supports both portrait and landscape orientations; and
the screen display method comprising the following steps of the image processing apparatus:
receiving the screen image and the application information from the portable terminal apparatus;
judging whether or not the application supports both portrait and landscape orientations with reference to the application information received therefrom; and
making the display of the image processing apparatus to display the screen image received from the portable terminal apparatus such that at least one part of the screen image is enlarged in a direction of the length of the screen image, if it is judged that the application supports either portrait or landscape orientation and the orientation supported by the application does not match the orientation of the display screen of the display of the image processing apparatus.

8. An image processing apparatus being capable of connecting with an portable terminal apparatus, the image processing apparatus comprising:
a receiver that receives a screen image and application information from the portable terminal apparatus, the screen image being displayed on the portable terminal apparatus, the application information representing whether an application related to reproduction of the screen image supports both portrait and landscape orientations,
a first judgment portion that judges whether or not the application supports both portrait and landscape orientations with reference to the application information received by the receiver;
a display having a portrait or landscape display screen; and
a display control processor that makes the display to display the screen image received by the receiver such that at least one part of the screen image is enlarged in a direction of the length of the screen image, if the first judgment portion judges that the application supports either portrait or landscape orientation and the orientation supported by the application does not match the orientation of the display screen of the display.

9. The image processing apparatus according to claim 8, wherein:
the display has a landscape display screen and the application supports only portrait orientation;
multiple operation keys are horizontally aligned at intervals on the screen image; and
the display control processor makes the display to display the screen image such that the multiple operation keys are horizontally aligned at longer intervals.

10. The image processing apparatus according to claim 8, further comprising a request transmitter that transmits a request for a screen image to the portable terminal apparatus, the screen image being oriented with respect to the orientation of the display screen of the display, if the first judgment portion judges that the application supports both portrait and landscape orientations.

11. The image processing apparatus according to claim 10, further comprising a second judgment portion that judges whether or not the screen image received by the receiver is oriented with respect to the orientation of the display screen of the display, wherein the request transmitter transmits a request for a screen image to the portable terminal apparatus, the screen image being oriented with respect to the orientation of the display screen of the display, if the second judgment portion judges that the screen image received thereby is not oriented with respect to the orientation of the display screen of the display.

12. The image processing apparatus according to claim 8, further comprising:
an orientation changer that allows the display to change the orientation of the display screen between portrait and landscape as the display is rotated; and
a third judgment portion that judges whether the display screen of the display is oriented with respect to portrait or landscape by the orientation switch;
wherein the display control processor makes the display of the image processing apparatus to display the screen image received by the receiver such that at least one part of the screen image is enlarged at least in a direction of the length of the screen image, if the first judgment portion judges that the application supports either portrait or landscape orientation and the orientation supported by the application does not match the orientation of the display screen of the display, the orientation being judged by the third judgment portion.

13. The image processing apparatus according to claim 8, further comprising a fourth judgment portion that judges whether or not the image processing apparatus has the first judgment portion, wherein the first judgement portion is enabled if the fourth judgment portion judges that the image processing apparatus has the first judgment portion.

14. A non-transitory computer-readable recording medium for an image processing apparatus comprising a display having a portrait or landscape display screen, the image processing apparatus being capable of connecting with a portable terminal apparatus, the non-transitory computer-readable recording medium storing a screen display program with instructions to make a computer of the image processing apparatus execute the following steps:
receiving a screen image and application information from the portable terminal apparatus, the screen image being displayed on the portable terminal apparatus, the application information representing whether an application related to reproduction of the screen image supports both portrait and landscape orientations,
judging whether or not the application supports both portrait and landscape orientations with reference to the application information received therefrom; and
making the display to display the screen image received therefrom such that at least one part of the screen image is enlarged in a direction of the length of the screen image, if it is judged that the application supports either portrait or landscape orientation and the orientation supported by the application does not match the orientation of the display screen of the display.

15. The non-transitory computer-readable recording medium according to claim 14, wherein the screen display program includes further instructions to make the computer of the image processing apparatus execute processing, wherein:
the display has a landscape display screen and the application supports only portrait orientation;
multiple operation keys are horizontally aligned at intervals on the screen image; and
the screen image is displayed on the display such that the multiple operation keys are horizontally aligned at longer intervals.

16. The non-transitory computer-readable recording medium according to claim 14, wherein the screen display program includes further instructions to make the computer of the image processing apparatus further execute the step of: transmitting a request for a screen image to the portable terminal apparatus, the screen image being oriented with respect to the orientation of the display screen of the display, if it is judged that the application supports both portrait and landscape orientations.

17. The non-transitory computer-readable recording medium according to claim 16, wherein the screen display program includes further instructions to make the computer of the image processing apparatus further execute the step of: judging whether or not the screen image received therefrom is oriented with respect to the orientation of the display screen of the display, wherein a request for a screen image is transmitted to the portable terminal apparatus, the screen image being oriented with respect to the orientation of the display screen of the display, if it is judged that the screen image received therefrom is not oriented with respect to the orientation of the display screen of the display.

18. The non-transitory computer-readable recording medium according to claim 14, wherein the screen display program includes further instructions to make the computer of the image processing apparatus further execute the steps of:
allowing the display to change the orientation of the display screen between portrait and landscape; and
judging whether the display screen of the display is oriented with respect to portrait or landscape by the orientation change,
wherein the screen image received therefrom is displayed on the display such that at least one part of the screen image is enlarged at least in a direction of the length of the screen image, if it is judged that the application supports either portrait or landscape orientation and the orientation supported by the application does not match the orientation of the display screen of the display, the orientation being judged.
